(19) United States
(12) Patent Application Publication
(10) Pub. No.: US 2026/0145410 A1
(43) Pub. Date: May 28, 2026

(54) LAMINATE FILM AND CONTAINER

(71) Applicant: YUPO CORPORATION, Tokyo (JP)

(72) Inventor: Ryota TOYAMA, Ibaraki (JP)

(73) Assignee: YUPO CORPORATION, Tokyo (JP)

(21) Appl. No.: 19/130,626

(22) PCT Filed: Oct. 26, 2023
(86) PCT No.: PCT/JP2023/038655

§ 371 Date: May 16, 2025

(30) Foreign Application Priority Data
Nov. 22, 2022 (JP) 2022-186457

(51) Int. Cl. B32B 27/08; B32B 27/20; B32B 27/32; B32B 37/12; B32B 37/15

(52) U.S. Cl. CPC B32B 27/08; B32B 27/205; B32B 27/32; B32B 37/1207; B32B 37/15; B32B 2250/03; B32B 2250/242; B32B 2264/104; B32B 2264/107; B32B 2264/303; B32B 2305/026; B32B 2307/31; B32B 2307/50; B32B 2319/00; B32B 2323/046; B32B 2323/10; B32B 2325/00; B32B 2439/00

(57) ABSTRACT

Provided is a laminate film that can be easily peeled off during the crushing process by hand or machine, but is difficult to peel off under normal conditions of use. A laminate film (10) has a substrate layer (1) and an easily breakable layer (3) in this order. The substrate layer contains an olefin-type resin, and the easily breakable layer contains the olefin-type resin, a resin incompatible with the olefin-type resin, and particles.

### TECHNICAL FIELD

The present invention relates to a laminate film and a container.

### BACKGROUND ART

Conventionally, laminate films having a heat sealing layer are used as in-mold labels. Such an in-mold label is set in a mold used to form a container, and is bonded to the surface of the container by the heat during molding. Since the label is bonded at the same time as the container is molded, the label is almost integrated with the container and has an appearance as if it were printed directly on the container.

The adhesive strength of an in-mold label to a container is adjusted so that the label is not peeled off under normal conditions of use, such as when the container is stored or transported (see, for example, Patent Literature 1). On the other hand, there is a proposal for an in-mold label provided with a detachable part with weak adhesive strength as a grip for peeling the label from the container (see, for example, Patent Literature 2).

### CITATION LIST

### Patent Literature

Patent Literature 1: Japanese Patent Laid-Open No. 2002-258752
Patent Literature 2: Japanese Patent Laid-Open No. 2004-264825

### SUMMARY OF INVENTION

### Technical Problem

In recent years, from the viewpoint of environmental protection, resin containers are increasingly being recycled. Containers may be melted and recycled into resin materials, such as pellets. For example, in the case of a container made of polyethylene terephthalate, and a laminate film made of polypropylene, recycling the labeled container as is results in the contamination of a large amount of different materials in recycled products.

In addition, laminate films are often printed. When a labeled container is recycled, the ink in the laminate film may cause coloration of recycled products, such as pellets. In addition to the ink, adhesives, coating agents, and other additives in the laminate film are heated and degraded during the production of recycled products, which may cause coloration of the recycled products.

Therefore, it is necessary to peel off the label from the labeled container; however, the laminate film bonded through a heat sealing layer adheres strongly to the surface of the container. For this reason, it is difficult to peel off the entire film by hand, and even if it can be peeled off, part of the film remains on the container. As described above, since it is difficult to recycle labeled containers as resin raw materials for the containers, labeled containers are mostly incinerated as fuel.

An object of the present invention is to provide a laminate film that can be easily peeled off during the crushing process by hand or machine, but is difficult to peel off under normal conditions of use.

### Solution to Problem

As a result of intensive research to achieve the above object, the present inventors have found that the object can be achieved by providing an easily breakable layer between a heat seal layer, which is bonded to a container, and a substrate layer, and incorporating multiple resins incompatible with each other in the easily breakable layer to facilitate layer misalignment (cohesive failure) in the easily breakable layer. Thus, the present invention has been completed.

That is, the present invention is as follows.

[1]A laminate film comprising a substrate layer and an easily breakable layer in this order, the substrate layer comprising an olefin-type resin, the easily breakable layer comprising the olefin-type resin, a resin incompatible with the olefin-type resin, and particles, wherein the particles have an average particle size of 3 to 20 μm, the particles are contained in an amount of 15 parts by mass or less relative to all resin components in the easily breakable layer, and the easily breakable layer has a void ratio of 10% or less.

[2] The laminate film according to [1], comprising a heat sealing layer on a surface of the easily breakable layer on a side opposite to the substrate layer, wherein the heat sealing layer comprises a resin with a lower melting point than that of the olefin-type resin.

[3] The laminate film according to [1], wherein the particles of the easily breakable layer have a particle size distribution D90/D10 of 1 to 5.

[4] The laminate film according to [1], wherein the easily breakable layer is a stretched film.

[5] The laminate film according to [1], wherein the heat sealing layer further comprises a lubricant.

[6] The laminate film according to [1], further comprising a coating layer for printing on a surface of the substrate layer on a side opposite to the heat sealing layer.

[7] The laminate film according to [1], wherein the easily breakable layer has a peel strength of 100 to 300 gf/15 mm.

[8]A container with the laminate film according to any one of [1] to [7] attached to a resin container body.

### Advantageous Effect of Invention

According to the present invention, it is possible to provide a laminate film that can be easily peeled off during the crushing process by hand or machine, but is difficult to peel off under normal conditions of use.

### BRIEF DESCRIPTION OF DRAWING

FIG. 1 A cross-sectional view showing an example of a laminate film.

### DESCRIPTION OF EMBODIMENTS

The laminate film of the present invention and a container to which the laminate film is attached will be described in detail below. The following is an example or representative example of the present invention, and the present invention is not limited thereto.

In the following explanation, the “easily breakable layer” refers to a resin layer that imparts releasability to the extent that it can be easily peeled off during the crushing process by hand or machine, but is difficult to peel off under normal conditions of use. The main component refers to the component whose content in the layer is 50 wt. % or more, and preferably 70 mass %.

### [Laminate Film]

The laminate film of the present invention is a thermoplastic film laminate having a substrate layer, an easily breakable layer, and a heat sealing layer in this order. The substrate layer contains a thermoplastic resin, such as an olefin-type resin. The easily breakable layer contains a thermoplastic resin, such as an olefin-type resin, a resin incompatible with the olefin-type resin, and particles. The particles of the easily breakable layer have an average particle size of 3 to 20 μm, and are preferably contained in an amount of 15 parts by mass or less relative to all resin components in the easily breakable layer. The easily breakable layer preferably has a void ratio of 10% or less. The heat sealing layer contains, for example, a resin with a lower melting point than that of the olefin-type resin. The smoothness of the heat sealing layer is, for example, 50 to 200 s.

The laminate film of the present invention can be attached to a container through the heat sealing layer. Although it is not particularly limited, for example, the laminate film can be used as an in-mold label to be attached during molding of an ethylene-based resin container. The laminate film can also be used as an anti-counterfeiting security label.

In general, when used as an in-mold label, a laminate film is placed inside a mold for forming a container, and attached to the container surface through the heat sealing layer melted by the heat during molding. Thus, the laminate film is bonded to the container in an integrated manner, and its adhesive strength is so high that it is difficult to peel off the label by hand. If an attempt is made to forcibly peel off the label, the label will be broken and remain on the container.

However, the laminate film of the present invention has an easily breakable layer between the substrate layer and the heat sealing layer. The easily breakable layer contains multiple resins and particles, which cause layer misalignment of incompatible resins within the layer, leading to cohesive failure. This makes it easy to peel off the in-mold label from the container when recycling.

The particles of the easily breakable layer have a predetermined average particle size, and the particles of the easily breakable layer are contained in a certain proportion. This has the effects of improving air release during in-mold molding (blister prevention), controlling the variation in releasability of each product, and the like.

When the laminate film is peeled off from the container, the heat sealing layer remains on the container side. If a part of the heat sealing layer contains the same material as the resin container, for example, if the heat sealing layer and the resin container contain an ethylene-based resin, the heat sealing layer can be recycled together with the container. Since the substrate layer, which is made of a different material from the container and may contain various additives, is separated from the container together with the easily breakable layer, the container can be easily recycled as its resin material. Further, if a coating layer for printing is formed on the surface of the substrate layer on a side opposite to the heat sealing layer, the coating layer can also be removed from the container together with the easily breakable layer.

On the other hand, in addition to releasability, the laminate film is also required to have properties that make it difficult for the label to peel off under normal conditions of use, such as during storage, transportation, and printing. Therefore, in the present invention, from the viewpoint of interlayer adhesion (compatibility), it is preferable that the substrate layer and the easily breakable layer contain a specific olefin-type resin. Moreover, from the viewpoint of compatibility, it is also preferable that the easily breakable layer further contains a specific elastomer. Further, from the viewpoint of compatibility, it is also preferable that the heat sealing layer contains a specific olefin-type elastomer. The interlayer adhesion between the substrate layer and the easily breakable layer, and between the easily breakable layer and the heat sealing layer, can be increased to a certain degree by incorporating materials that are compatible with each other in each layer, and the label can have a property of being difficult to peel off under normal conditions of use.

The heat sealing layer also contains a resin with a lower melting point than that of the olefin-type resin selected for the substrate layer and the easily breakable layer in relation to the other layers of the laminate film, from the viewpoint of heat-sealing properties. In addition, the smoothness of the heat sealing layer is adjusted within a specific range, from the viewpoint of preventing blocking and blistering.

The laminate film of the present invention can be used for adherends other than containers, as long as it can be thermally fused. In this case, from the viewpoint of recycling of the adherend, the material of the adherend is preferably of the same type as some of the components of the heat sealing layer. For example, the material of the adherend is an ethylene-based resin.

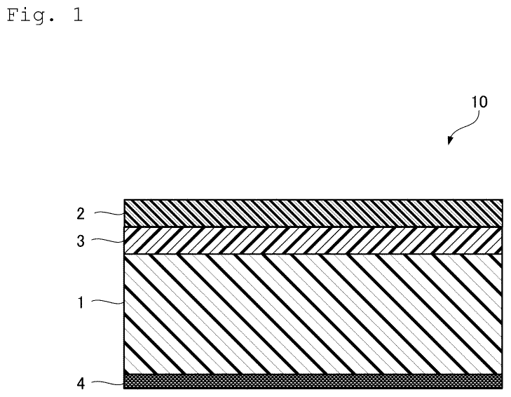

Here, FIG. 1 is a cross-sectional view showing an example of the laminate film.

The laminate film 10 shown in FIG. 1 has a substrate layer 1, a heat sealing layer 2 on one surface of the substrate layer 1, and an easily breakable layer 3 between the substrate layer and the heat sealing layer 2. When printing on the surface of the substrate layer 1 on a side opposite to the heat sealing layer 2, a coating layer 4 may be provided for printing letters, pictures, and the like by printing.

Each layer will be described below.

### (1. Substrate Layer)

The substrate layer functions as a support for the laminate film. The substrate layer is preferably a resin film from the viewpoint of imparting the desired stiffness and firmness to the laminate film, and further imparting water resistance. The resin that can be used for the substrate layer is preferably an olefin-type resin due to its excellent mechanical strength.

### <Olefin-Type Resin>

Specific examples of the olefin-type resin include polypropylene, polyethylene, polymethyl-1-pentene, and the like.

Among these, the substrate layer is preferably a resin film containing polypropylene as a main component. Polypropylene not only has excellent mechanical strength, but also increases interlayer adhesion or compatibility with the same or similar olefin-type resin (e.g., polypropylene) contained in the adjacent easily breakable layer. Accordingly, when the label is peeled off from the container, the cohesive failure within the easily breakable layer is prioritized instead of the interface failure between the substrate layer and the easily breakable layer. Therefore, contamination of different materials caused by interface failure during recycling can be avoided.

### <Polypropylene>

The polypropylene is not particularly limited as long as propylene is used as its main monomer. Examples include isotactic or syndiotactic polymers obtained by homopolymerizing propylene. Other usable examples include propylene-α-olefin copolymers, which are copolymers of propylene as the main component and an α-olefin, such as ethylene, 1-butene, 1-pentene, 4-methyl-1-pentene, 1-hexene, 1-heptene, or 1-octene. The copolymer may use a binary monomer component or a tertiary or higher monomer component, and may be either a random copolymer or a block copolymer. A propylene homopolymer and a propylene copolymer may be used in combination.

As the polypropylene, graft-modified polypropylene can be used, if necessary, from the viewpoint of improving the adhesiveness between the film and the adjacent layer, or moldability.

Known methods can be used for graft modification. Specific examples include graft modified products using an unsaturated carboxylic acid or a derivative thereof as a grafting monomer. Examples of the unsaturated carboxylic acid include acrylic acid, methacrylic acid, maleic acid, fumaric acid, itaconic acid, citraconic acid, and the like. Examples of derivatives of these unsaturated carboxylic acids include acid anhydrides, esters, amides, imides, metal salts, or the like of the unsaturated carboxylic acids.

Specific grafting monomers include maleic anhydride, itaconic anhydride, citraconic anhydride, methyl acrylate, ethyl acrylate, acrylamide, and the like.

The grafting monomer can be generally used in an amount of 0.005 to 10 mass %, and preferably 0.01 to 5 mass %, relative to the polypropylene.

As the polypropylene used in the substrate layer, those mentioned above may be used singly or in combination of two or more. From the viewpoint of moldability, mechanical strength, cost, or the like, a propylene homopolymer is preferred because it is easy to handle as the main component of the substrate layer.

The substrate layer may be a film using only polypropylene as the thermoplastic resin, or may contain a thermoplastic resin other than polypropylene within the range that does not impair the effects of the present invention. Examples of thermoplastic resins that can be used in combination include ethylene-based resins, such as high-density polyethylene, medium-density polyethylene, and linear low-density polyethylene; polyamide-based resins, such as nylon-6 and nylon-6,6; thermoplastic polyester-based resins, such as polyethylene terephthalate or a copolymer thereof, polybutylene terephthalate, and aliphatic polyesters including polybutylene succinate and polylactic acid; polycarbonates; styrene-based resins, such as atactic polystyrene or syndiotactic polystyrene; and the like.

### <Filler>

The substrate layer may further contain a filler. The inclusion of a filler makes it easy to adjust the whiteness or opacity of the substrate layer. Examples of usable fillers include inorganic fillers, organic fillers, and the like.

The substrate layer is preferably a stretched porous film formed by stretching a film containing a filler, so that pores are formed inside the film with the filler as a core. During in-mold molding, the heat sealing layer is melted due to the heat transmitted from the mold; however, when the laminate film is porous, it has higher insulation properties, so that there is less heat loss, and the heat sealing layer can be melted efficiently and sufficiently. In addition, by making the substrate layer porous, the laminate film can be made lighter.

### <<Inorganic Filler>>

Usable examples of inorganic fillers include inorganic particles, such as calcium carbonate, calcined clay, silica, diatomaceous earth, white clay, talc, titanium oxide, barium sulfate, barium titanate, alumina, zeolite, mica, and glass fibers; and preferred among these is calcium carbonate in terms of low price, easy availability, and less adverse effects on the resins. The average particle size of the inorganic filler measured by laser diffraction using a particle size distribution meter is generally 0.01 to 15 μm, and preferably 0.1 to 5 μm.

As the filler, the inorganic fillers and organic fillers mentioned above can be used singly or in combination of two or more.

From the viewpoint of making the substrate layer porous, the content of the filler in the substrate layer (when an inorganic filler and an organic filler are used in combination, then the total amount thereof) is preferably 10 mass % or more, and preferably 15 mass % or more, and is preferably 60 mass % or less, and more preferably 50 mass % or less.

### <Other Components>

The substrate layer may further contain, if necessary, additives, such as a heat stabilizer (antioxidant), a light stabilizer, a dispersant, a lubricant, or a nucleating agent.

As the heat stabilizer, for example, a sterically hindered phenol-based antioxidant, phosphorus-based antioxidant, or amine-based antioxidant can be generally used within the range of 0.001 to 1 mass %.

As the light stabilizer, for example, a sterically hindered amine-based light stabilizer, benzotriazole-based light stabilizer, or benzophenone-based light stabilizer can be generally used within the range of 0.001 to 1 mass %.

Examples of the dispersant or lubricant include silane coupling agents, higher fatty acids such as oleic acid and stearic acid, metal soaps, polyacrylic acid, polymethacrylic acid, or salts thereof, and the like. These can be generally used within the range of 0.01 to 4 mass %, for example, for the purpose of dispersing the filler.

### <Layer Structure>

The substrate layer may have a single-layer structure or a multilayer structure with two layers or three or more layers. The substrate layer with a multilayer structure can have various functions, such as mechanical properties, writability, abrasion resistance, and suitability for secondary processing.

The substrate layer preferably contains a stretched film that is stretched at least in a uniaxial direction, and more preferably contains a stretched porous film having pores inside due to stretching. Since the substrate layer containing a stretched film has high dimensional stability and mechanical strength, and excellent thickness uniformity, a laminate film with excellent post-processability can be obtained.

When the substrate layer has a multilayer structure, the number of stretching axes of each layer may be 1 axis/1 axis, 1 axis/2 axes, 2 axes/1 axis, 1 axis/1 axis/2 axes, 1 axis/2 axes/1 axis, 2 axes/1 axis/1 axis, 1 axis/2 axes/2 axes, 2 axes/2 axes/1 axis, or 2 axes/2 axes/2 axes.

### <Porosity>

From the viewpoint of weight reduction, whitening, or the like, the porosity of the substrate layer is preferably 10% or more. From the viewpoint of maintaining strength, the porosity is preferably 60% or less, and more preferably 40% or less.

The porosity can be calculated from the ratio of the area occupied by pores to a certain region of the cross section of the film observed under an electron microscope.

### (Heat Sealing Layer)

The heat sealing layer imparts heat sealability to the laminate film. The laminate film can be attached to the container through the heat sealing layer.

The heat sealing layer may further contain an olefin-type elastomer in addition to a low-melting-point resin as the main component, which imparts heat sealability, from the viewpoint of interlayer adhesion to the easily breakable layer and from the viewpoint of imparting strength. Further, from the viewpoint of preventing blocking, it is preferable that a lubricant is further contained. Each component will be described below.

The main component of the heat sealing layer is not particularly limited as long as it can impart heat sealability, but has a melting point lower than that of the olefin-type resin contained in the substrate layer and the easily breakable layer. Further, from the viewpoint of facilitating heat sealing, it is preferable to use a low-melting-point resin. The low-melting-point resin is a thermoplastic resin having a melting point of 135° C. or lower. The melting point of the low-melting-point resin is preferably 120° C. or lower. When the melting point is 135° C. or lower, even if the molding temperature is low, adhesion with sufficient strength can be easily achieved. From the viewpoint of preventing the softening of the heat sealing layer under high temperature conditions in the summer, which causes blocking between in-mold labels during storage, the melting point of the low-melting-point resin is preferably 60° C. or higher.

Usable low-melting-point resins are not particularly limited as long as they have a melting point of 135° C. or lower. Specific examples include homopolymers of olefins typified by ethylene, propylene, butene, pentene, hexene, methyl pentene, and octene; copolymers of two or more of these olefins; copolymers of one or more of these olefins and one or more comonomers copolymerizable with the olefins; and metal salts thereof. Examples of comonomers copolymerizable with olefins include styrenes, such as styrene and α-methyl styrene; vinyl carboxylates, such as vinyl acetate, vinyl propionate, vinyl butyrate, vinyl pivalate, vinyl caproate, vinyl laurate, vinyl stearate, vinyl benzoate, and vinyl butyl benzoate; acrylic acids, such as acrylic acid, methacrylic acid, acrylic ester, methacrylic ester, and acrylonitrile; and the like.

From the viewpoint of adhesion to resin containers, preferred among the above resins are olefin-type resins, such as high-density polyethylene, medium-density polyethylene, low-density polyethylene, or metallocene catalyst-based polyolefins including metallocene catalyst-based polypropylene. From the viewpoint of low melting point and good moldability, low-density polyethylene is more preferred.

### <Low-Density Polyethylene (LDPE)>

Low-density polyethylene (LDPE), which is used as a main component of the heat sealing layer, has a density (g/cm³) of 0.900 or more and less than 0.935, and a tensile impact strength of 250 kJ/m² or less. The density is preferably 0.930 g/cm³ or less, and more preferably 0.925 g/cm³ or less. The tensile impact strength is measured according to JIS K6922-2, and the upper limit is preferably 230 kJ/m² or less, and more preferably 220 kJ/m² or less, whereas the lower limit is generally 100 kJ/m² or more, preferably 150 kJ/m² or more, and even more preferably 180 kJ/m² or more. Examples of low-density polyethylene include high-pressure low-density polyethylene produced by a high-pressure method, low-pressure low-density polyethylene produced by a low-pressure method using a Ziegler-Natta catalyst, and the like.

### <Olefin-Type Elastomer>

The heat sealing layer preferably contains an olefin-type elastomer, from the viewpoint of interlayer adhesion to the easily breakable layer, and from the viewpoint of imparting strength. The olefin-type elastomer in the heat sealing layer has fluidity (plasticity) at high temperatures and rubber-like elasticity (elastomer) at room temperature, and refers to a polymer material having a hard segment component made of polyolefin, such as polyethylene or polypropylene, and a soft segment component made of another polyolefin, an α-olefin such as 1-butene, 1-hexene, 1-heptene, or 4-methyl-1-pentene, or ethylene-propylene rubber. Known olefin-type elastomers are random copolymers, block copolymers, blended materials, dynamically crosslinked materials, sea-island dispersions, and the like; however, the type thereof is not particularly limited. The olefin-type elastomer may be a two-component elastomer, or an elastomer with three or more components. In addition, the olefin-type elastomer can be a mixture of two or more types with different compositions.

The olefin-type elastomer can be any of various known elastomers and is not particularly limited. Preferred among these are random copolymers and block copolymers, and more preferred are olefin-type elastomers (R-TPO), which are so-called reactor-made random copolymers and block copolymers. Even more preferred among these are olefin-type elastomers (R-TPO) that are random copolymers, and particularly preferred are metallocene catalyst-based polypropylene-based elastomers (R-TPO) copolymerized using a metallocene catalyst.

The elasticity of the olefin-type elastomer is preferably 100 MPa or less, more preferably 50 MPa or less, and even more preferably 20 MPa or less. When the elasticity is equal to or less than the above upper limit value, sufficient interlayer adhesion to the easily breakable layer can be easily obtained, and sufficient strength can be imparted. The lower limit of the elasticity is not particularly limited, but is generally 0.1 MPa or more, and from the viewpoint of suppressing excessive adhesion, it is preferably 0.5 MPa or more.

The elasticity is measured in the following manner.

The olefin-type elastomer is pressed into a sheet of 500 μm thickness using a hydraulic press, and this sheet is cut into a test piece measuring 30 mm in length and 15 mm in width. The dynamic viscoelasticity of the test piece is measured using a solid viscoelasticity measuring device (produced by TA Instruments Japan Inc.: RSA-III). The measurement conditions are as follows: a chuck distance of 20 mm, a measurement frequency of 10 Hz, a strain of 0.1%, a temperature increase rate of 10° C./min, and tensile mode. The storage elasticity in the TD direction (vertical direction) at 23° C. is determined as elasticity.

### <Lubricant>

From the viewpoint of preventing blocking, the heat sealing layer preferably contains a lubricant. Examples of lubricants include higher fatty acids such as oleic acid and stearic acid, metal soaps, polyacrylic acid, polymethacrylic acid, or salts thereof, and the like. Preferred among these are higher fatty acids such as oleic acid and stearic acid, and particularly preferred is ethylene bisoleic acid amide (EBOA).

When the surface smoothness of the heat sealing layer is adjusted, and air flow paths are formed between the container and the heat sealing layer during in-mold molding, the formation of blisters can be reduced through the flow paths.

### (Easily Breakable Layer)

The easily breakable layer imparts, to the laminate film, releasability that allows the film to be easily peeled off during the crushing process by hand or machine, and adhesiveness that make the film difficult to peel off under normal conditions of use. The easily breakable layer contains a thermoplastic resin, such as an olefin-type resin, a resin incompatible with the olefin-type resin, and particles. The particles of the easily breakable layer have an average particle size of 3 to 20 μm, and are preferably incorporated in an amount of 15 parts by mass or less relative to all resin components in the easily breakable layer. The void ratio of the easily breakable layer is preferably 10% or less, and more preferably 5% or less. This is because if there are fewer voids, handling difficulties such as the voids being crushed when the label is heat-pressed onto a bottle, which would change the properties of the label, are less likely to occur. Further, the peel strength of the easily breakable layer is preferably 100 to 300 gf/15 mm. From the viewpoint of imparting compatibility (interlayer adhesion), for example, the easily breakable layer preferably contains a styrene-based elastomer. In order to reduce quality variations, the particle size distribution D90/D10 of the particles in the easily breakable layer is preferably 1 to 5. From the viewpoint of breakability, the easily breakable layer is preferably a stretched film.

### <Olefin-Type Resin>

Regarding the olefin-type resin, the resins referred to in the <Olefin-type resin> section for the substrate layer can be used.

<Resin Incompatible with Olefin-Type Resin>

The resin incompatible with the olefin-type resin is incompatible with the olefin-type resin in the easily breakable layer, causing layer misalignment and facilitating cohesive failure of the easily breakable layer. Examples of incompatible resins include styrene-based resins, polycarbonate resins, and ester-based resins. Preferred among these are styrene-based resins.

### <<Styrene-Based Resin>>

Specific examples of styrene-based resins include polystyrene, acrylonitrile styrene resin (AS resin), acrylonitrile butadiene styrene resin (ABS resin), and the like. From the viewpoint of showing incompatibility with the olefin-type resin, and from the viewpoint of easy availability, it is preferable to use polystyrene.

### <Particles>

The particles in the easily breakable layer have a larger diameter than that of the filler mixed in the substrate, and are incorporated in a small amount. From the viewpoint of imparting releasability and preventing blister (air release during molding), the particles preferably have a specific average particle size, and from the viewpoint of stably imparting releasability, the particles are preferably incorporated in a specific amount.

As the particles in the easily breakable layer, the same ones as the filler in the substrate layer can be used. Preferred among these is zeolite in terms of low cost, easy availability, and ease of control of particle size and particle size distribution.

The lower limit of the average particle size (D50) of the particles is preferably 3 μm or more, more preferably 5 μm or more, and particularly preferably 7 μm or more. The upper limit is preferably 20 μm or less, more preferably 15 μm or less, and particularly preferably 10 μm or less. If the average particle size is less than the lower limit or more than the upper limit, sufficient releasability and blister properties are less likely to be imparted.

The particle size distribution of the particles is represented by D90/D10. A D90/D10 value closer to 1 indicates sharp particle size distribution. 1 is a theoretical value, and the value will never be less than 1.

In the formula, D90 indicates a particles size that is 90% of the cumulative value in the volume frequency particle size distribution measurement. D50 indicates a particles size that is 50% of the cumulative value in the volume frequency particle size distribution measurement, and D50 also indicates the average particle size. D10 indicates a particles size that is 10% of the cumulative value in the volume frequency particle size distribution measurement.

The particles according to the present invention preferably have a D90/D10 value of, as the upper limit, 5 or less, preferably 3 or less, and even more preferably 2.5 or less. The lower limit is 1 or more as a theoretical value.

The upper limit of the amount of the particles is preferably 15 parts by mass or less, more preferably 13 parts by mass or less, and particularly preferably 11 parts by mass or less, relative to all resin components in the easily breakable layer. If the amount of the particles exceeds the upper limit, stable releasability performance is difficult to achieve, and variations occur for each product. The lower limit of the amount of the particles incorporated is preferably 0.5 parts by mass or more, more preferably 1 part by mass or more, and particularly preferably 3 parts by mass or more. If the amount of the particles is less than the lower limit, the function of imparting roughness as (large-size) particles is not demonstrated.

### <Styrene-Based Elastomer>

By incorporating a styrene-based elastomer into the easily breakable layer, the adhesiveness in the easily breakable layer increases, and moldability is improved. Examples of the styrene-based elastomer include A-B-A type block polymers, such as styrene-butadiene-styrene (SBS), styrene-isoprene-styrene (SIS), styrene-ethylene-butylene copolymer-styrene (SEBS), styrene-ethylene-propylene-styrene (SEPS), and styrene-butadiene-butylene-styrene (SBBS); A-B block polymers, such as styrene-butadiene (SB), styrene-isoprene (SI), a styrene-ethylene-butylene copolymer (SEB), and a styrene-ethylene-propylene copolymer (SEP); styrene-based random copolymers, such as styrene-butadiene rubber (SBR); A-B-C type styrene-olefin crystalline block polymers, such as styrene-ethylene-butylene copolymer-olefin crystals (SEBC); and the like. Preferred among these is styrene-butadiene-styrene (SBS), from the viewpoint of operability.

The elasticity of the styrene-based elastomer is preferably 100 MPa or less, more preferably 50 MPa or less, and even more preferably 20 MPa or less. When the elasticity is equal to or less than the above upper limit value, sufficient interlayer adhesion to the heat sealing layer can be easily obtained. The lower limit of the elasticity is not particularly limited, but is generally 0.1 MPa or more, and from the viewpoint of suppressing excessive adhesion, it is preferably 0.5 MPa or more.

The elasticity is measured in the following manner.

The styrene-based elastomer is pressed into a sheet of 500 μm thickness using a hydraulic press, and this sheet is cut into a test piece measuring 30 mm in length and 15 mm in width. The dynamic viscoelasticity of the test piece is measured using a solid viscoelasticity measuring device (produced by TA Instruments Japan Inc.: RSA-III). The measurement conditions are as follows: a chuck distance of 20 mm, a measurement frequency of 10 Hz, a strain of 0.1%, a temperature increase rate of 10° C./min, and tensile mode. The storage elasticity in the TD direction (vertical direction) at 23° C. is determined as elasticity.

From the viewpoint of suppressing unnecessary peeling under normal conditions of use, the content of the styrene-based elastomer in the easily breakable layer is 15 parts by mass or more, preferably 25 parts by mass or more, and even more preferably 40 mass % or more, based on 100 parts by mass of the sum of resin components in the easily breakable layer.

From the viewpoint of easily peeling the easily breakable layer from the heat sealing layer when applying force by hand, the content of the styrene-based elastomer in the easily breakable layer is 65 parts by mass or less, and preferably 55 parts by mass or less, based on 100 parts by mass of the sum of resin components in the easily breakable layer.

The easily breakable layer may contain the additives referred to in the <Other components> section for the substrate layer within the range that does not impair the effects of the present invention.

### (Coating Layer)

When printing on the label, it is preferable to provide a coating layer for printing on the surface of the substrate layer on a side opposite to the heat sealing layer, from the viewpoint of adhesion to the ink. Further, a printed layer may be laminated on the coating layer, or the coating layer itself may be a printed layer. In the latter case, a coating layer is formed by directly printing on the surface of the substrate layer on a side opposite to the heat sealing layer. In the former case, a coating layer can be formed, for example, by applying a coating agent to the surface of the substrate layer.

### [Characteristics of Laminate Film]

### (Thickness)

The thickness of the substrate layer is preferably 10 μm or more, and more preferably 30 μm or more. When the thickness of the substrate layer is equal to or more than the above lower limit value, laminate films with the desired stiffness and firmness tend to be obtained. On the other hand, the thickness of the substrate layer is preferably 300 μm or less, and more preferably 150 μm or less. When the thickness of the substrate layer is equal to or less than the above upper limit value, the flexibility of the laminate film is easily increased, and the laminate film can easily follow the shape of the container.

The thickness of the heat sealing layer is preferably 1 μm or more. When the thickness of the heat sealing layer is equal to or more than the above lower limit value, sufficient adhesive strength to the container can be easily obtained. On the other hand, the thickness of the heat sealing layer is preferably 50 μm or less. When the thickness of the heat sealing layer is equal to or less than the above upper limit value, stickiness is reduced, and the laminate film can be easily cut, which tends to improve the workability of the laminate film.

The thickness of the easily breakable layer is preferably 0.1 μm or more, and more preferably 0.5 μm or more, from the viewpoint of reducing peeling under normal conditions of use. From the viewpoint of facilitating peeling by hand, the thickness of the easily breakable layer is preferably 10 μm or less, and more preferably 5 μm or less.

### (Smoothness)

The smoothness of the surface of the laminate film on the heat sealing layer side is preferably 1000 s or less, more preferably 350 s or less, even more preferably 300 s or less, and particularly preferably 250 s or less. When the smoothness is equal to or less than the above upper limit value, surface irregularities on the heat sealing layer side increase, and air flow paths are easily formed between the heat sealing layer and the container. It is possible to form flow paths that allow air entering during attachment to fully escape to the outside, reducing the formation of blisters. The lower limit value of the smoothness is generally 10 s or more, preferably 100 s or more, more preferably 120 s or more, and even more preferably 160 s or more.

The smoothness is Oken smoothness measured according to JIS-P8119: 1998.

The smoothness can be adjusted within the above range by incorporating particles into the easily breakable layer.

### (Peel Strength)

From the viewpoint of reducing peeling under normal conditions of use, the peel strength between the substrate layer and the heat sealing layer in the laminate film is preferably 450 gf/15 mm or less, more preferably 400 gf/15 mm or less, and even more preferably 300 gf/15 mm or less. From the viewpoint of easy peeling by hand after use, the peel strength is preferably 25 gf/15 mm or more, more preferably 50 gf/15 mm or more, and even more preferably 100 gf/15 mm or more.

The peel strength is measured as the peeling force obtained in a T-type tensile test at a drawing speed of 300 mm/min according to JIS K6854-2: 1999 in a test environment at a temperature of 20 to 23° C. with a humidity of 50 to 60% RH.

### [Method for Producing Laminate Film]

The method for producing the laminate film of the present invention is not particularly limited. For example, the laminate film of the present invention can be produced by forming a film of each layer, and laminating the films.

### (Film Formation)

As a method of forming the film of each layer, for example, cast molding, calender molding, rolling molding, or inflation molding can be used to extrude the molten resin into a sheet using a single-layer or multilayer T-die, I-die, or the like connected to a screw-type extruder. The film may be formed by cast or calender molding of a mixture of a resin and an organic solvent or oil, and then removing the solvent or oil.

Film lamination methods include a co-extrusion method, an extrusion lamination method, a coating method, and the like, and these methods can also be used in combination. In the co-extrusion method, resin compositions of the respective layers melted and kneaded in different extruders are laminated and extruded in a feed block or multi-manifold, and film formation and lamination are performed in parallel. In the extrusion lamination method, a resin composition is melt-extruded onto a preformed film to form and laminate another film. In the coating method, a resin solution, emulsion, or dispersion is applied onto a film and dried to form and laminate another film. The heat sealing layer can be provided not only by co-extrusion or lamination, but also by coating or application.

### (Stretching)

The layers may be stretched individually before lamination or together after lamination. A non-stretched layer and a stretched layer may be laminated and then stretched again.

Examples of usable stretching methods include a longitudinal stretching method utilizing the difference in peripheral speed of rolls, a transverse stretching method using a tenter oven, a sequential biaxial stretching method combining these methods, a rolling method, a simultaneous biaxial stretching method using a combination of a tenter oven and a pantograph, a simultaneous biaxial stretching method using a combination of a tenter oven and a linear motor, and the like. Another usable method is a simultaneous biaxial stretching (inflation molding) method, in which a molten resin is extruded into a tubular shape using a circular die connected to a screw-type extruder, and then air is blown into the tubular shape.

When the thermoplastic resin used in the film is an amorphous resin, the stretching temperature during stretching is preferably equal to or higher than the glass transition temperature of the thermoplastic resin. When the thermoplastic resin is a crystalline resin, the stretching temperature is preferably equal to or higher than the glass transition point of the amorphous portion of the thermoplastic resin and equal to or lower than the melting point of the crystalline portion of the thermoplastic resin. Specifically, the stretching temperature is preferably 2 to 60° C. lower than the melting point of the thermoplastic resin.

The stretching speed is not particularly limited, but is preferably within the range of 20 to 350 m/min, from the viewpoint of stable stretch-molding.

The draw ratio can be appropriately determined in consideration of the characteristics of the thermoplastic resin used and the like. For example, when a resin film containing a homopolymer or copolymer of propylene is stretched in one direction, the draw ratio is generally 1.2 times or more, and preferably 2 times or more, whereas generally 12 times or less, and preferably 10 times or less. The draw ratio in the case of biaxial stretching is, as the area draw ratio, generally 1.5 times or more, and preferably 10 times or more, whereas generally 60 times or less, and preferably 50 times or less.

### (Formation of Coating Layer)

A coating layer for printing can be formed on the surface of the substrate layer on a side opposite to the heat sealing layer.

Examples of the printing method that can be used after the coating layer is formed include offset printing, gravure printing, flexo printing, letterpress printing, screen printing, an inkjet recording method, a thermal recording method, a thermal transfer recording method, an electrophotographic recording method, and other various known methods. Preferred among these is offset printing, gravure printing, or flexo printing, by which printed matter with excellent weather resistance and water resistance is likely to be obtained. Gravure printing is preferred for package use. Further, as the printing ink, oil-based ink, water-based ink, UV-curable ink, or the like can be used.

### (Processing of Laminate Film)

The laminate film of the present invention may be cut, punched, or the like to the shape or size required for bonding to the container.

### [Container]

The container of the present invention preferably contains a resin of the same type as the resin contained, at least in part, in the heat sealing layer of the laminate film. For example, when the heat sealing layer contains low-density polyethylene, the container body may contain an ethylene-based resin. In this case, the laminate film described above is attached to the container body, and such a labeled container can be produced by heat-sealing the surface of the laminate film on the heat sealing layer side to the container body. Specifically, as described above, the laminate film is used as an in-mold label, and the laminate film can be bonded by the heat during in-mold molding of the container.

Examples of the ethylene-based resin that can be used in the container body include high-density polyethylene with a density of 0.940 to 0.965 g/cm³, medium-density polyethylene with a density of 0.925 to 0.935 g/cm³, and the like.

### EXAMPLES

The present invention will be described in more detail below with reference to Examples; however, the present invention is not limited to the following Examples. In the Examples, the descriptions such as “parts” and “%” are on a mass basis, unless otherwise noted.

### [Raw Materials]

Table 1 shows a list of the raw materials used in the Examples and Comparative Examples.

TABLE 1

| Category | Symbol | Material |
|---|---|---|
| Polyolefin-type | h-PP | Propylene homopolymer |
| resin | | Product name: Novatec PP FY-4, |
| | | produced by Japan Polypropylene |
| | | Corporation, MFR (230° C., |
| | | 2.16 kg load): 5.0 g/10 min, |
| | | Melting point: 165° C. |
| Resin | PS | Polystyrene resin |
| incompatible with | | Product name: HIPS 475D, |
| polyolefin-type | | produced by PS Japan Corporation, |
| resin | | MFR (200° C., 2.16 kg |
| | | load): 2 g/10 min) |
| Low-melting- | LD-PE | High-pressure low-density polyethylene |
| point resin | | Product name: Novatec LD LC522, |
| | | produced by Japan Polyethylene |
| | | Corporation, MFR (190° C., |
| | | 2.16 kg load): 4 g/10 min, |
| | | Melting point: 112° C. |
| | PO-based | α-olefin copolymer |
| | elastomer | Product name: Tafmer PN3560, |
| | | produced by Mitsui Chemicals, Inc., |
| | | MFR (230° C., 2.16 kg |
| | | load): 6.0 g/10 min, |
| | | Melting point: 160° C. |
| Compatibilizer | SBS | Styrene-butadiene copolymer |
| | | Product name: P2000 produced |
| | | by Asahi Kasei Corporation, |
| | | MFR (230° C., 2.16 kg |
| | | load): @@ g/10 min, |
| | | Melting point: 160° C. |
| Filler | Calcium | Heavy calcium carbonate fine powder |
| | carbonate | Product name: Softon #1800, |
| | | produced by Bihoku Funka |
| | | Kogyo Co., Ltd., |
| | | Volume average particle |
| | | size: 1.8 um |
| Large-size | Zeolite | Zeolite |
| particles | | Product name: Silton AMT 100 |
| | | produced by Mizusawa |
| | | Industrial Chemicals, Ltd. |
| | | Average particle size (D50) |
| | | 8 um, particle size |
| | | distribution D90/D10) |
| | | 2.5 or less |
| Lubricant | EBOA | Ethylene bisoleic acid amide |
| | | Product name: Slipax O, produced |
| | | by Nihon Kasei Co., Ltd., |
| | | Melting point119° C. |

### [Production of Laminate Film]

### Example 1

A resin composition (a) composed of 84 parts by mass of a thermoplastic resin (propylene homopolymer, product name: Novatec PP FY-4, produced by Japan Polypropylene Corporation, MFR (230° C., 2.16 kg load): 5.0 g/10 min, melting point: 165° C.) and 16 parts by mass of a filler (heavy calcium carbonate fine powder, product name: Softon #1800, produced by Bihoku Funka Kogyo Co., Ltd., volume average particle size: 1.8 μm) was melt-kneaded in an extruder set at 230° C. Thereafter, the resulting mixture was supplied to an extrusion die set at 250° C. and extruded into a sheet, which was then cooled to 60° C. using a cooling device to obtain a non-stretched sheet. The non-stretched sheet was heated at 135° C., and stretched 5 times in the longitudinal direction utilizing the difference in peripheral speed of rolls to form a substrate layer.

Then, 70 parts by mass of low-density polyethylene (high-pressure low-density polyethylene, product name: Novatec LD LC522, produced by Japan Polyethylene Corporation, MFR (190° C., 2.16 kg load): 4 g/10 min, density: 0.923 g/cm³), 30 parts by mass of polyolefin-type elastomer (α-olefin copolymer, product name: Tafmer PN3560, produced by Mitsui Chemicals, Inc., MFR (230° C., 2.16 kg load): 6.0 g/10 min, melting point: 160° C.), and 0.5 parts by mass of a lubricant (ethylene bisoleic acid amide, product name: Slipax O, produced by Nihon Kasei Co., Ltd., melting point: 119° C.) were melt-kneaded in an extruder set at 250° C. to prepare a resin composition (b) for forming a heat sealing layer.

In another extruder, 45 parts by mass of a thermoplastic resin (propylene homopolymer, product name: Novatec PP FY-4, produced by Japan Polypropylene Corporation, MFR (230° C., 2.16 kg load): 5.0 g/10 min, melting point: 165° C.), 45 parts by mass of a polystyrene-based resin (polystyrene resin, product name: HIPS 475D, produced by PS Japan Corporation, MFR (200° C., 2.16 kg load): 2 g/10 min)), 1 part by mass of a compatibilizer (styrene-butadiene copolymer, product name: P2000, produced by Asahi Kasei Corporation, MFR (230° C., 2.16 kg load): @@g/10 min, melting point: 160° C.), and 8 parts by mass of large-size particles (zeolite, product name: Silton AMT100, produced by Mizusawa Industrial Chemicals, Ltd., average particle size: 8 um) were supplied. This mixture was melt-kneaded in an extruder set at 250° C. to prepare a resin composition (c) for forming an easily breakable layer.

Then, the resin compositions (b) and (c) were stacked in sheets and co-extruded from the respective extruders on the substrate layer, thereby obtaining a three-layer sheet in which the substrate layer, the easily breakable layer, and the heat sealing layer were laminated in this order. The three-layer sheet was cooled to 60° C. using a cooling device, then heated at about 150° C. using a tenter oven, and stretched 8.5 times in the transverse direction. Then, the sheet was heated to 160° C. and then cooled to 60° C., and the ears were slit.

As a result, a laminate film in which the substrate layer, the easily breakable layer, and the heat sealing layer were laminated in this order (total layer thickness: 100 μm, thickness of each layer: 70 μm/20 μm/10 μm, number of stretching axes of each layer: 2 axes/1 axis/1 axis) was obtained. This laminate film was punched to a size of 63 mm×125 mm to obtain a laminate film of Example 1.

### Examples 2 and 3, and Comparative Example 3

Thereafter, laminate films of Examples 2 and 3, and Comparative Example 3 were obtained in the same manner as in Example 1, except that the amounts of the thermoplastic resin and polystyrene-based resin incorporated in the easily breakable layer were changed as shown in the following Table 2.

### Example 4

A laminate film of Example 4 was obtained in the same manner as in Example 1, except that the amount of the compatibilizer incorporated in the easily breakable layer was changed as shown in the following Table 2.

### Comparative Examples 1 and 2

Laminate films of Comparative Examples 1 and 2 were obtained in the same manner as in Example 1, except that the amount of the large-size particles incorporated in the easily breakable layer was changed as shown in the following Table 2. Further, in the case of Comparative Example 2, the surface of the obtained laminate film on the heat sealing layer side was embossed.

### [Measurement of Physical Properties]

The laminate films of the Examples and Comparative Examples were measured for the smoothness of the surface on the heat sealing layer side and the peel strength of the heat sealing layer and the easily breakable layer.

### (Smoothness)

The Oken smoothness (s) of the surface of the laminate films on the heat sealing layer side was measured according to JIS-P8119: 1998.

### (Peel Strength)

Each laminate film was used as an in-mold label to produce a labeled container.

Each laminate film was fixed to one of the split molds for blow molding using a vacuum. At this time, the laminate film was fixed so that the substrate layer side was in contact with the mold. On the other hand, high-density polyethylene (HDPE) (product name: Novatec HD HB330, produced by Japan Polychem Corporation, melting point: 134° C.) was melt-extruded at 200° C. to form a parison. This parison was used to tighten the split molds, and 4.2 kg/cm² of compressed air was supplied into the parison. The parison was thus inflated, shaped into a container, and thermally fused with the laminate film. After molding, the molds were cooled and opened to obtain a labeled hollow resin container with a capacity of 1000 ml.

The label part of the labeled resin container was cut off with a cutter to take a sample for measurement with a length of 12 cm and a width of 15 mm. Next, the label was carefully peeled off about 1 cm from the edge of the sample for measurement to form a grip. Based on JIS K6854-2: 1999, the sample for measurement was set in a tensile testing machine (Autograph AGS-5kNJ, produced by Shimadzu Corporation), and a 180-degree peel test was conducted at a peeling speed of 300 mm/min. The average peel strength (gf/15 mm) with a peel length between 25 mm and 75 mm was determined.

In the measurement of the peel strength, it was confirmed in the following manner that peeling occurred between each layer and the easily breakable layer.

(1) The label peeled from the resin container was measured by FTIR, and there were no peaks due to the components used in the heat sealing layer, for example, the polyethylene component.

(2) No white opaque fragments were visually confirmed on the resin container side.

The fragments confirmed in (2) above are fragments of the substrate layer remaining on the resin container side due to the breakage of the substrate layer. If the label is peeled off due to the breakage of the substrate layer, the white opaque substrate layer with pores formed by the filler remains on the surface of the resin container. Therefore, when no white opaque cross-section can be visually confirmed, it is presumed that the label can be peeled off without the breakage of the substrate layer. When the substrate layer with pores and the lowest mechanical strength is not broken, it is not considered that the easily breakable layer is broken. In addition, the substrate layer and the easily breakable layer both use polypropylene, and the adhesion between them is stronger than that between the easily breakable layer and the heat sealing layer; thus, peeling is considered to occur between the easily breakable layer and the heat sealing layer.

### [Evaluation]

The laminate films of the Examples and Comparative Examples were evaluated for blister suppression and easy peelability in the following manner.

### (Production of Labeled Container)

Each laminate film was used as an in-mold label to produce a labeled container. The labeled container was produced in the same manner as in the measurement of the interlayer strength described above.

### (Blister Suppression)

In the label part of the labeled resin container, the presence of floating or blistering caused by the peeling of the label was visually observed, and blister suppression was evaluated according to the following criteria.
A (good): There were no blisters.
B (acceptable): There were 3 or fewer small blisters with a diameter of 0.5 mm or less.
E (not acceptable): There were blisters with a diameter exceeding 0.5 mm, or 4 or more small blisters with a diameter of 0.5 mm or less.

### (Peeling Stability (Breakable Stability))

After the edge of the label part was peeled by nails from the labeled container, the peeled part was grasped by the hand, and the label was peeled from a position at an angle of 180° relative to the surface of the container body. At this time, how the label was peeled was observed, and peeling stability by hand was evaluated according to the following criteria.

A (Good): The entire label could be peeled off from the container body, and no pieces of the label remained on the container body.

B (acceptable): The entire label could be peeled off from the container body, but some pieces of the label remained on the container body.

E (not acceptable): The entire label could not be peeled off from the container body, and pieces of the label remained on the container body.

### (Printing Suitability)

The laminate films of the Examples and Comparative Examples were each cut into A5 size, and then humidified for 1 day in an environment at a temperature of 23° C. and a relative humidity (RH) of 50%. Thereafter, solid printing was performed on the coating layer of printing paper with an ink volume of 2.0 g/m². For printing, UV flexo ink (product name: Flexo 500, produced by T&K TOKA Co., Ltd.) was used.

Then, UV irradiation was performed using a UV irradiation machine so that the irradiation intensity was 100 mJ/cm² to obtain a sample for evaluating ink adhesion. The sample was visually observed, and printing performance was evaluated from the uniformity of printing according to the following criteria.
A: No ink shading was observed (passed)
B: Slight ink shading was observed (passed)
E: Ink shading was observed (failed)
   (Prevention of Printing Defects after Storage)

The laminate films of the Examples and Comparative Examples were each cut into A5 size, and then humidified for 1 day in an environment at a temperature of 23° C. and a relative humidity (RH) of 50%. Thereafter, 100 sheets were stacked, set in a press, and pressed at a pressure of 5 MPa for 5 minutes. After pressing, the 50th laminate film counting from the top was extracted, and printed and measured in the same manner as for printing suitability described above, and the prevention of printing defects after storage was confirmed (whether the lubricant was transferred by pressure due to storage in a stacked state to reduce printing suitability).

Table 2 shows the evaluation results.

TABLE 2

| | | | | | | | | Comparative | | |
|---|---|---|---|---|---|---|---|---|---|---|
| | | | | Example | | | | Example | | |
| Example | | | | 1 | 2 | 3 | 4 | 1 | 2 | 3 |
| Component | Coating layer | | | Formed | Formed | Formed | Formed | Formed | Formed | Formed |
| | Substrate | h-PP | parts by | 84 | | | | 84 | | |
| | layer | | weight | | | | | | | |
| | | CaCO3 | parts by | 16 | | | | 16 | | |
| | | | weight | | | | | | | |
| | Easily | h-PP | parts by | 45 | 70 | 20 | 45 | 45 | 45 | 90 |
| | breakable | | weight | | | | | | | |
| | layer | PS | parts by | 45 | 20 | 70 | 45 | 45 | 45 | 0 |
| | | | weight | | | | | | | |
| | | SBS | parts by | 1 | 1 | 1 | 0 | 1 | 1 | 1 |
| | | | weight | | | | | | | |
| | | Zeolite | parts by | 8 | 8 | 8 | 8 | 0 | 0 | 8 |
| | | (particles) | weight | | | | | | | |

| | | | | |
|---|---|---|---|---|
| HS layer | LD-PE | parts by | 70 | 70 |
| | | weight | | |
| | PO-based | parts by | 30 | 30 |
| | elastomer | weight | | |
| | EBOA | parts by | 0.5 | 0.5 |
| | (lubricant) | weight | | |

| Molding | HS layer embossed or not | | — | — | — | — | — | Embossed | — |
|---|---|---|---|---|---|---|---|---|---|
| Physical | Smoothness of HS layer | | 210 | 200 | 220 | 200 | 20000 | 230 | 220 |
| properties | Peel strength | | 200 | 270 | 150 | 150 | 210 | 180 | Unmea- |
| | | | | | | | | | surable |
| Evaluation | Breakable stability | | A | B | B | B | B | A | E |
| | Printability | Printing suitability | A | A | A | A | A | A | A |
| | | Prevention of printing | A | A | A | A | A | E | A |
| | | defects after storage | | | | | | | |

| | | | | | | | |
|---|---|---|---|---|---|---|---|
| Blister prevention | A | A | A | A | E | A | A |

Examples 1 to 4 all had a peel strength of 100 (gf/15 mm) or more, confirming that there was sufficient adhesiveness to prevent peeling during use of the labeled container. On the other hand, Examples 1 to 4 all had an interlayer strength of 300 (gf/15 mm) or less, and easy peelability was good, which indicates that the film can be easily peeled off by hand.

When comparing Example 1 and Comparative Example 1, blisters were observed in Comparative Example 4, in which no large-size particles were incorporated into the easily breakable layer. When comparing Example 1 and Comparative Example 2, in Comparative Example 2, in which the easily breakable layer was embossed instead of incorporating large-size particles therein, the surface became regularly uneven, and the lubricant in the heat sealing layer was excessively transferred, resulting in transfer failure. When comparing Example 1 and Comparative Example 3, in Comparative Example 3, in which a styrene-based resin, which is an incompatible resin, was not incorporated in the easily breakable layer, no easy breakage occurred, and the label could not be peeled off by hand.

The present application claims priority based on Japanese Patent Application No. 2022-186457 filed on Nov. 22, 2022, the entire contents of which are incorporated herein by reference.

### REFERENCE SIGNS LIST

10 . . . Laminate film
1 . . . Substrate layer
2 . . . Heat sealing layer
3 . . . Easily breakable layer
4 . . . Coating layer

1. A laminate film comprising a substrate layer and an easily breakable layer in this order,
the substrate layer comprising an olefin-type resin,
the easily breakable layer comprising the olefin-type resin, a resin incompatible with the olefin-type resin, and particles, wherein the particles have an average particle size of 3 to 20 μm, the particles are contained in an amount of 15 parts by mass or less relative to all resin components in the easily breakable layer, and the easily breakable layer has a void ratio of 10% or less.

2. The laminate film according to claim 1, comprising a heat sealing layer on a surface of the easily breakable layer on a side opposite to the substrate layer,
wherein the heat sealing layer comprises a resin with a lower melting point than that of the olefin-type resin.

3. The laminate film according to claim 1, wherein the particles of the easily breakable layer have a particle size distribution D90/D10 of 1 to 5.

4. The laminate film according to claim 1, wherein the easily breakable layer is a stretched film.

5. The laminate film according to claim 1, wherein the heat sealing layer further comprises a lubricant.

6. The laminate film according to claim 1, further comprising a coating layer for printing on a surface of the substrate layer on a side opposite to the heat sealing layer.

7. The laminate film according to claim 1, wherein the easily breakable layer has a peel strength of 100 to 300 gf/15 mm.

8. A container with the laminate film according to claim 1 attached to a resin container body.
